(19) United States
(12) Patent Application Publication
(10) Pub. No.: US 2016/0362156 A1
(43) Pub. Date: Dec. 15, 2016

(54) Gravity Propelled Apparatus

(71) Applicants: Wei Song, Houston, TX (US); Feng Zhu, Chang Tu (CN); Ning Zhu, Beijing (CN)

(72) Inventors: Wei Song, Houston, TX (US); Feng Zhu, Chang Tu (CN); Ning Zhu, Beijing (CN)

(21) Appl. No.: 14/717,214

(22) Filed: Jun. 12, 2015

(51) Int. Cl. B62M 1/00; B62K 3/00

(52) U.S. Cl. CPC B62M 1/00; B62K 3/002

(57) ABSTRACT

A gravity propelled apparatus overcomes shortages of a scooter's dull movement and limited moving in horizontal direction of a pogo. It comprises a handlebar, a support rod, a central assembly provided with foot-rests, front leg and rear leg with front wheel and rear wheel, transmission assembly, a cable and elastic things wind around transmission assembly.

When a rider steps on and fall down, the front leg and rear leg will separate each other and a cable will unwounded from transmission assembly and make a groove turning. A big-gear-wheel secured to groove will make rear wheel turn via a chain.

### CROSS-REFERENCE TO RELATED APPLICATIONS

None.

### FEDERALLY SPONSORED RESEARCH

None.

### SEQUENCE LISTING OR PROGRAM

None.

### BACKGROUND OF THE INVENTION

The Field of the Invention

The present invention relates to a novel apparatus especially for gravity propelled apparatus taking advantage of characteristics both scooter moving fast on the ground-level and pogo stick jumping up and down in the vertical direction.

Description of the Prior Art

Various scooter and pogo stick designs have been available for many years. Conventional scooters require the user to lift one foot from the scooter-board and touch the ground to kick back hard in order to get propulsion. It must be very tired for a longer riding. For pogo sticks, in addition, it can provide an exciting movement mode up and down by jumping for the user but it is greatly limited to move forward quickly. What is needed is a new improving design without such limitations.

### SUMMARY OF THE INVENTION

A Gravity Propelled Apparatus is designed for above purpose. It comprises a central assembly, a support rod with a handlebar rotably provided on upper end of the rod, a steering block-fork secured to upper part of the rod, a front leg and a rear leg rotably connected with both front end and rear end of the central assembly, two wheels are provided at each end of the front leg and the rear leg, transmission assembly provided underneath of the rear leg. An elastic things links the front leg with one end and wound around step-groove of transmission assembly with another end. By the aid of elastic things a user stands on foot-rests and can easily jumps up and falls down quickly. As gravity of human body apart two legs, a cable would pull the transmission assembly running as well rear wheel.

### BRIEF DESCRIPTION OF THE DRAWINGS

Preferred embodiment of the present invention will be two wheels scooter type apparatus. Now it will be described with reference to drawings in which:

FIG. 1 is a perspective view of present invention.

FIG. 2 is an illustration of driving principle as two legs contracting.

FIG. 3 is an illustration of driving principle as two legs separating.

FIG. 4 is a perspective detail view of transmission assembly.

FIG. 5 is an illustration of steering system.

FIG. 6 is a detail view of central assembly, support rod, foot-rests and steering block-fork.

FIG. 7 is a side view of step-groove.

FIG. 8 is a 1-1 section view of FIG. 7

FIG. 9 is a perspective view of the synchronous assembly.

FIG. 10 is an illustration second type transmission assembly structure with internal gear.

FIG. 11 is a vertical view of FIG. 10.

FIG. 12 is a perspective detail view of FIG. 10.

FIG. 13 is a perspective view of second type transmission assembly.

FIG. 14 is an illustration of third type transmission assembly with two groups gears.

### DESCRIPTION OF THE PREFERRED EMBODIMENT

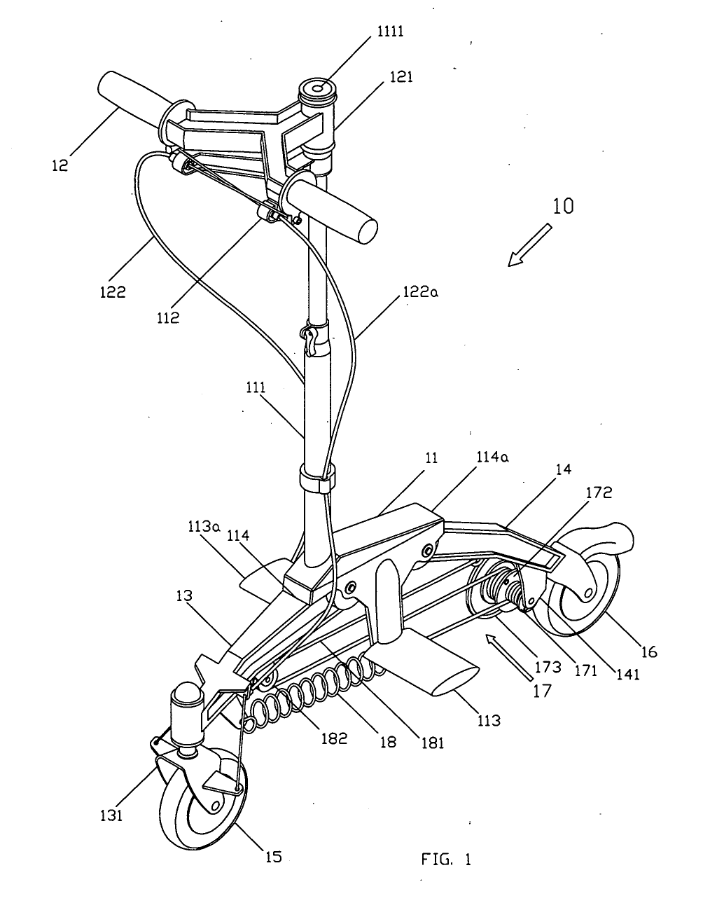

Referring first to FIG. 1: The device 10 includes:
Central assembly 11 provided with two foot-rests 113 and 113a on each side.
Support rod 111 secured at a lower end to front upper side of central assembly 11.
Steering limit-fork 112 secured to upper part of rod 111.
A handlebar 12 provided with sleeve 121 rotably connected with axle 1111 secured to an upper part of support rod 111.
Two steering wires 122 and 122a connected to handlebar 12 and fork 131.
Front leg 13 pivotally connected with an upper end to central assembly 11 and provided with a fork 131 and front wheel 15 at a lower end.
Rear leg 14 pivotally connected with an upper end to central assembly 11 and provided with rear wheel 16 at a lower end.
Transmission assembly 17 provide underneath of lower part of rear leg 14 and rotably supported by bearing 141 secured to rear leg 14. Transmission assembly 17 comprises a step-groove formed by first groove 171, second groove 172 and big-gear-wheel 173.
Elastic things 18 wound around first groove 171 and with another end secured to front leg 13. Cable 181 with one end wound around second groove 172 and connected with another end to rear leg 14 via pulley 182.

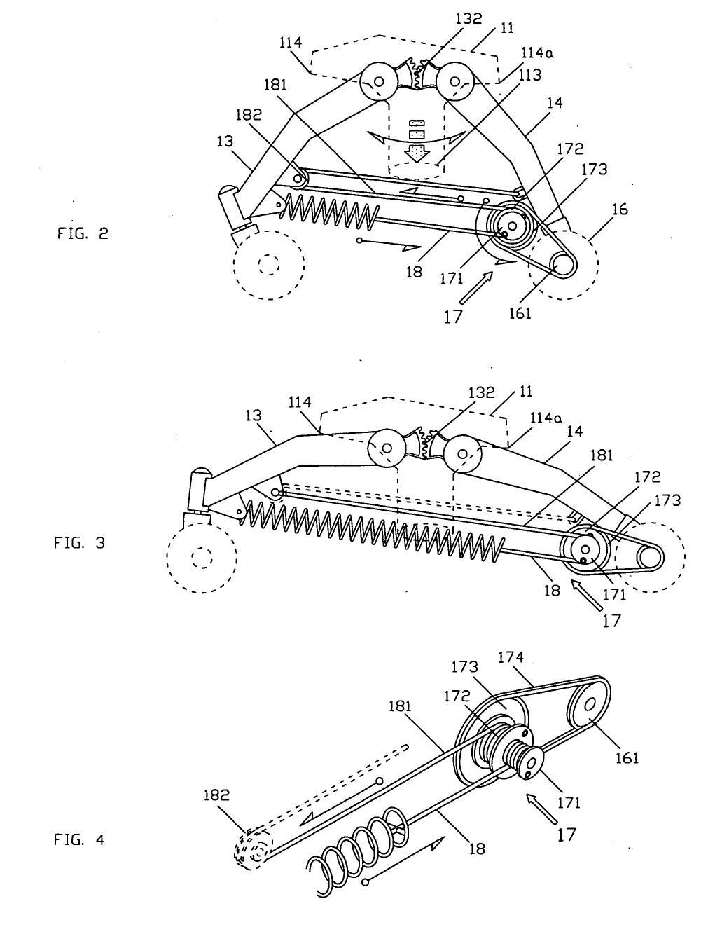

FIGS. 2, 3 and 4 illustrate driving principle. Elasticity of elastic things 18 should be smaller than weight of a rider. The rider stands on foot-rests 113 and 113a, the device 10 would fall down and two legs 13 and 14 will separate from each other simultaneously till to be blocked by turning-stoppers 114 and 114a. As the result of separating, cable 181 will be unwound from second groove 172 and elastic things 18 wound around first groove 171, pulling step-groove turning and big-gear-wheel 173 too. Via chain 174 free wheel 161 turns. Rear wheel 16 will be driven to move forward.

When the rider jumps up, elastic things 18 pull front leg 13 and rear leg 14 contract to each other and cable 181 will be wound around back second groove 172 again. Elastic things 18 unwound from first groove 171. Cable 181 can be secured either to rear leg 14 via pulley 182 (as shown in FIG. 2) or front leg 13 (as shown in FIG. 3).

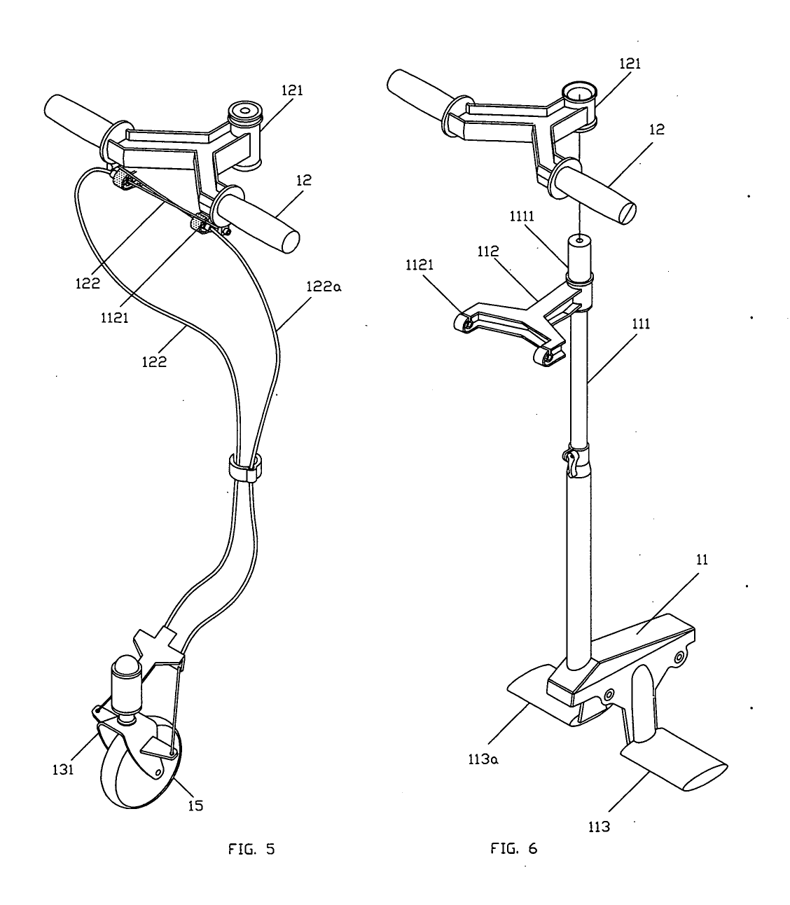

FIG. 5 shows work-mode of steering system. Steering wire 122 and 122a connected to handlebar 12 with one end and fork 131 with another end via notch 1121 at upper part. Turning handlebar 12, steering wire 122 or 122a pulls fork 131 turning accordingly working as line-brake of a bicycle.

FIG. 6 shows relationship of central assembly 11, support rod 111 and steering limit-fork 112. Notch 1121 provided at both front ends of steering limit-fork 112. Sleeve 121 provided at rear part of handlebar 12 coordinates with axle 1111.

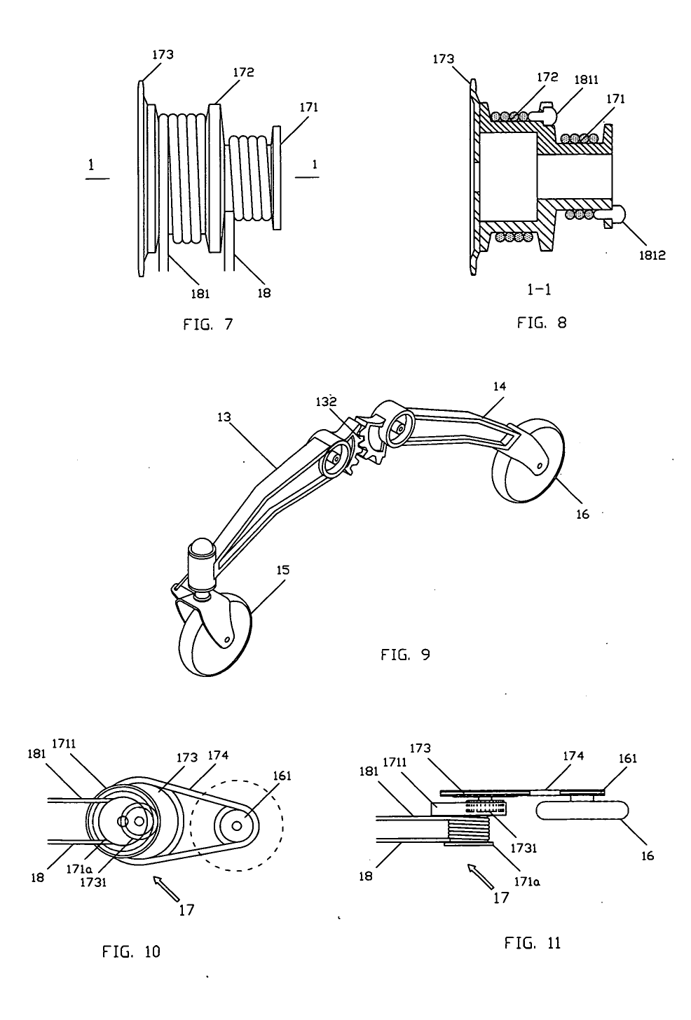

FIGS. 7, 8 shows first grooves 171 and second groove 172. Cable 181 winds around second groove 172 and secured to it by clip 1811. Elastic things 18 winds around first groove 171 and secured to it by clip 1812.

FIG. 9 is a diagram of synchronous device 132. Two group arc-gears mesh at \upper ends of front leg 13 and rear leg 14.

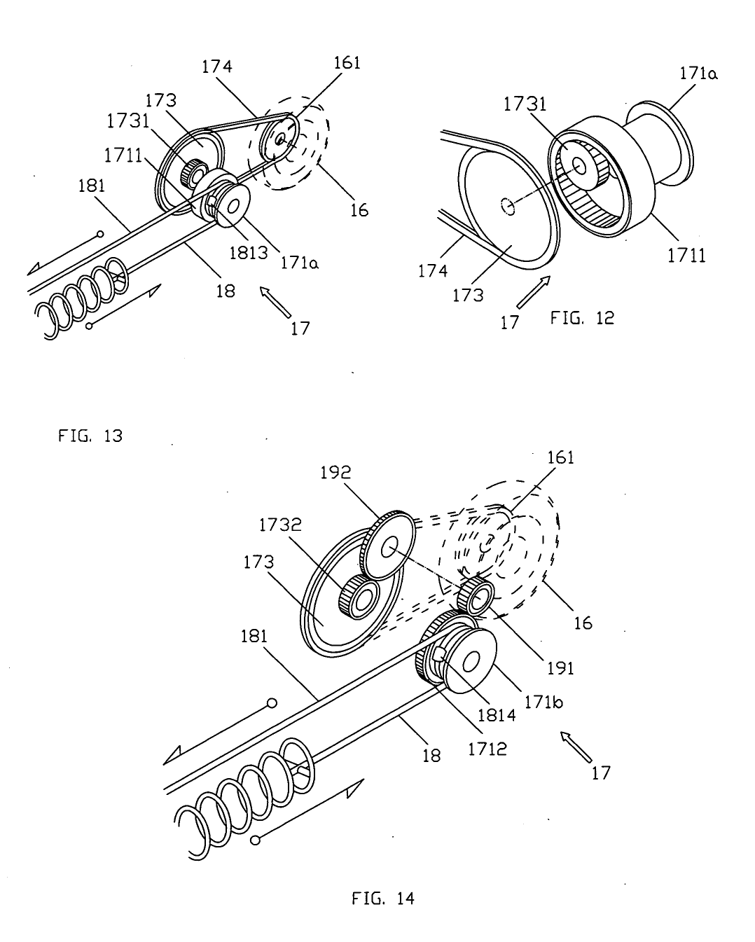

FIGS. 10, 11, 12 and 13 show second structure of transmission assembly 17 provided with internal gear transmission. Internal gear 1711 coaxially secured to groove 171a. Small gear 1731 meshed with internal gear 1711 and coaxially secured to big-gear-wheel 173. Cable 18 and elastic things 181 wound around and locked to groove 171a by clip 1813.

FIG. 14 show third structure of transmission assembly 17 provided with two group of accelerating gears. Gear 1712 coaxially secured to groove 171b. Small gear 191 meshed with gear 1712. Bigger gear 192 coaxially secured to small gear 191 meshed with second small gear 1732 secured to big-gear-wheel 173. Cable 18 and 181 locked to groove 171b by clip 1814. Cable 18 and elastic things 181 wound around and locked to groove 171b by clip 1813.

Although preferred embodiment of the present invention has been shown in the foregoing specification, it will, of course, be understood that various modifications and changes may be made therein without departing from the invention. It is therefore, intended that the following claims cover all such modification and changes as may fall within the true spirit and scope of the present invention.

What is claimed is:

1. A gravity propelled apparatus comprising:
(a). a central assembly means;
(b). a vertical support rod means with a lower end secured to a front upper side of said central assembly means;
(c). a pair of foot-rests secured to both sides of said central assembly means;
(d). two turning-stoppers provided at a front end and a rear end of said central assembly means;
(e). a handlebar means rotably mounted on an upper end of said vertical support rod means;
(f). a steering limit-fork with notches formed at both front ends secured to an upper part of said vertical support rod means below said handlebar means;
(g). a front leg means pivotally connected with a front part of said center assembly means;
(h). a fork rotably provided at a lower end of said front leg means;
(i) a front wheel mounted on said fork;
(j). a pair of steering-wires via said notches connected to said handlebar means and said fork;
(k) a rear leg means pivotally connected with a rear part of said central assembly means;
(l). a rear wheel coupled to a lower end of said rear leg means;
(m). a transmission assembly means comprised a step-groove formed by first groove and second groove and a big-gear-wheel provided underneath of a lower part of said rear leg means;
(n). an elastic things provided under said central assembly means with one end secured to a lower part of said front leg means and another end wound around and secured to said first groove;
(o). a cable with one end wound around and secured to said second groove and with another end secured to said front (or rear) leg means; and
(p). a synchronous assembly located at a mid-section of said central assembly means.

2. A gravity propelled apparatus according to claim 1 wherein said transmission assembly means further comprises a third groove, an internal gear secured to said third groove, said big-gear-wheel and a small gear secured to said big-gear-wheel meshed with said internal gear.

3. A gravity propelled apparatus according claim 1 wherein said transmission assembly means further comprises a third groove, a first driving-gear secured to said third groove, a first small driven gear meshed with said first driving-gear, a second driving-gear secured to said first small driven gear, a second small driven gear meshed with second driving-gear and said big-gear-wheel secured to said second small driven gear.

4. A gravity propelled apparatus according to claim 1 wherein said first and second grooves of said step-groove have different diameters.
